(19) United States
(12) Patent Application Publication
(10) Pub. No.: US 2012/0002180 A1
(43) Pub. Date: Jan. 5, 2012

(54) PROJECTION DEVICE WITH BRIGHTNESS ADJUSTMENT FUNCTION AND METHOD THEREOF

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/959,275

(22) Filed: Dec. 2, 2010

(30) Foreign Application Priority Data
Jun. 30, 2010 (TW) 99121376

(51) Int. Cl. G03B 21/14

(52) U.S. Cl. 353/85; 353/121

(57) ABSTRACT

A projection device with an illumination adjustment function is provided. The projection device includes a storage unit for storing a predetermined illumination range value; a lens module, a light source, a power supply unit, an optical sensor, a controller, a power controller, and an optical engine. The light source emits light onto a projection screen. The optical sensor receives the light reflected from the projection screen. The controller acquires an illumination value of the light, and compares whether the illumination value falls within the predetermined illumination range. The power controller adjusts a power from the power supply unit to the light source until the illumination value falls within the predetermined illumination range. The optical engine is controlled to operate the light when the illumination value of the light falls within the predetermined illumination range. The lens module focuses the light onto the projection screen.

### BACKGROUND

1. Technical Field

The present disclosure relates to projection devices and, particularly, to a projection device having a brightness adjustment function and a method for same.

2. Description of Related Art

In general, projection devices such as projectors are usually connected to an image output device, such as a video tape recorder or a VCD player. When the projection device projects images onto a projection screen in a room but the room is not dark enough, the images may be washed out.

### BRIEF DESCRIPTION OF THE DRAWINGS

FIG. 1 is a block diagram of a hardware infrastructure of a projection device with a brightness adjustment function in accordance with an exemplary embodiment.

FIG. 2 is a flowchart of a method having a brightness adjustment function implemented by the projection device of FIG. 1, in accordance with an exemplary embodiment.

### DETAILED DESCRIPTION

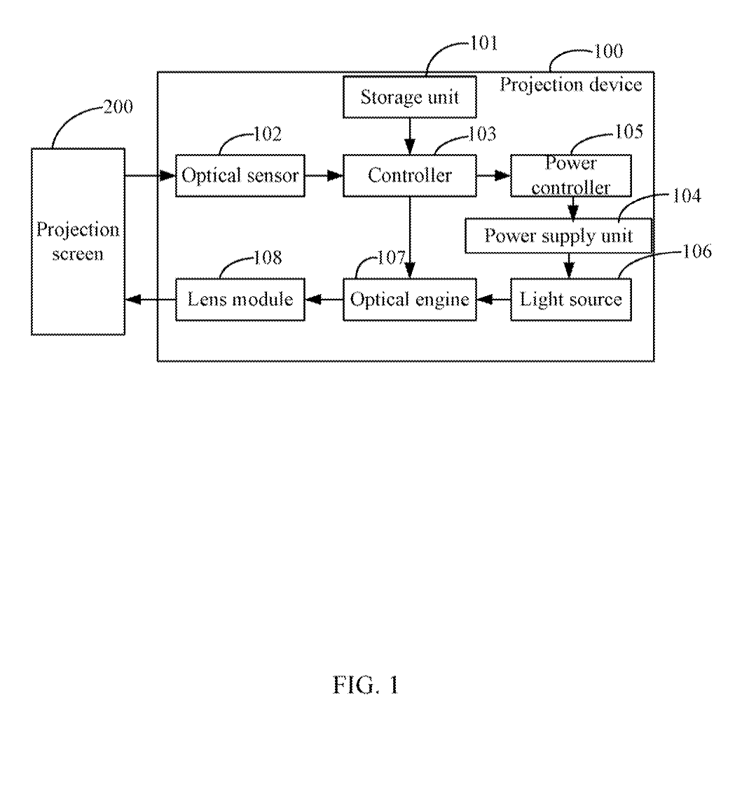

Referring to FIG. 1, a projection device 100 includes a storage unit 101, a light source 106, an optical sensor 102, a controller 103, a power controller 105, a power supply unit 104, an optical engine 107, and a lens module 108.

The storage unit 101 is used for storing a predetermined illumination range.

In one embodiment, the predetermined illumination range is from 750 lux to 1500 lux.

The light source 106 is used for emitting light to the lens module 108. The lens module 108 is used for projecting light onto a projection screen 200. In one embodiment, the light source 106 may be an LED, an LED RGB, etc.

The power supply unit 104 is used for supplying power to the light source 106 through the power controller 90, thereby controlling illumination value of the light source 106.

The optical sensor 102 is used for receiving light reflected from the projection screen 200. In one embodiment, the optical sensor 102 is a micro-electro mechanical system (MEMS) sensor.

The controller 103 is used for acquiring an illumination value of the light received by the optical sensor 102, and comparing whether the illumination value falls within the predetermined illumination range of the storage unit 101.

The power controller 105 is used for adjusting power from the power supply unit 104 to the light source 106 until the illumination value of the light from the light source 106 falls within the predetermined illumination range when the illumination value of the light from the light source 106 does not fall within the predetermined illumination range.

The optical engine 107 maybe any known optical engine used in projection technology and is controlled to operate only when the illumination value of the light from the light source 106 falls within the predetermined illumination range.

The lens module 108 focuses light from the optical engine 107 onto the projection screen 200.

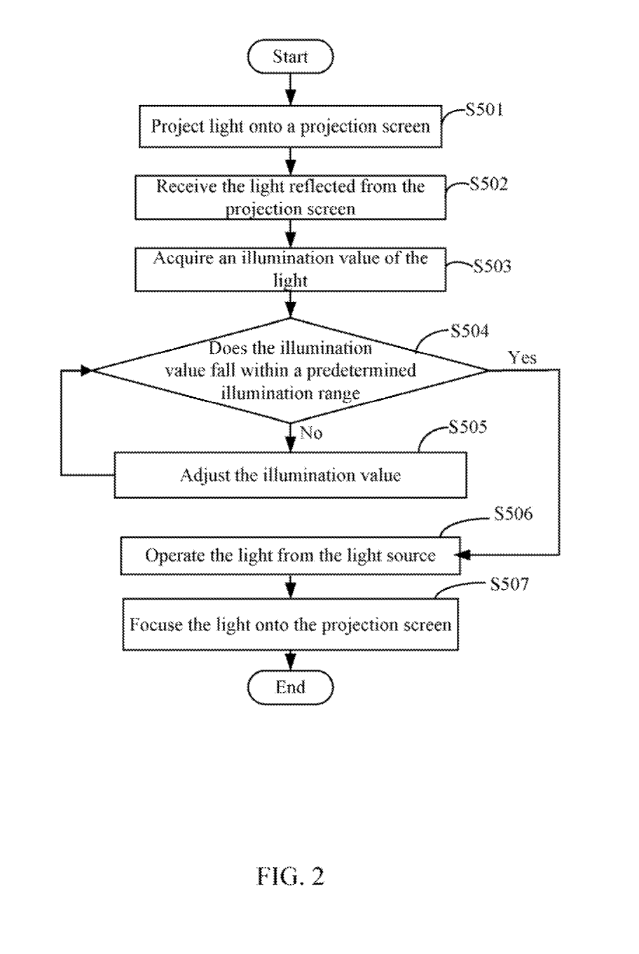

FIG. 2 is a flowchart of a method of a brightness adjustment function implemented by the projection device in accordance with an exemplary embodiment.

In step S501, the lens module 108 projects the light emitted from the light source 106 onto the projection screen 200.

In step S502, the optical sensor 102 receives the light reflected from the projection screen 200.

In step S503, the controller 103 acquires the illumination value of the light received by the optical sensor 102.

In step S504, the controller 103 compares whether the illumination value the light falls within the predetermined illumination range from 750 lux to 1500 lux of the storage unit 101, if yes, goes to step S506; if no, goes to step S505.

In step S505, the power controller 105 adjusts a power from the power supply unit 104 to the light source 106 and go back to Step S504 to check if the illumination value falls within the predetermined illumination range.

In step S506, the optical engine 107 is controlled to operate the light only.

In step S507, the lens module 108 focuses light from the optical engine 107 onto the projection screen 200.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A projection device with an illumination adjustment function comprising:
a storage unit for storing a predetermined illumination range value;
a lens module;
a light source for emitting light onto the lens module;
the lens module for projecting the light from the light source onto a projection screen;
a power supply unit for supplying power for the light source;
an optical sensor for receiving the light reflected from the projection screen;
a controller for acquiring an illumination value of the light received by the optical sensor, and comparing whether the illumination value falls within the predetermined illumination range;
a power controller for adjusting a power from the power supply unit to the light source until the illumination value of the light from the light source falls within the predetermined illumination range when the illumination value of the light does not fall within the predetermined illumination range;
an optical engine controlled to operate the light only when the illumination value of the light from the light source falls within the predetermined illumination range; and
a lens module for focusing the light from the optical engine onto the projection screen.

2. The projection device as described in claim 1, wherein the light source is an LED or an LED RGB.

3. The projection device as described in claim 1, wherein the optical sensor is a micro-electro mechanical system sensor.

4. The projection device as described in claim 1, wherein the predetermined illumination range is from 750 lux to 1500 lux.

5. A method with an illumination adjustment function implemented by a projection device; wherein the projection device comprises a storage unit for storing a predetermined illumination range value, a light source and a power supply unit, the method comprising:
emitting light onto a projection screen;
receiving the light reflected from the projection screen;
acquiring an illumination value of the light from the light source, and comparing whether the illumination value falls within the predetermined illumination range of the storage unit;
if the illumination value of the light does not fall within the predetermined illumination range, adjusting a power from the power supply unit for the light source until the illumination value of the light from the light source falls within the predetermined illumination value;
operating the light when the illumination value of the light from the light source does not fall within the predetermined illumination range; and
focusing the operated light onto the projection screen.
